(19) United States
(12) Patent Application Publication
(10) Pub. No.: US 2010/0064827 A1
(43) Pub. Date: Mar. 18, 2010

(54) DEVICE FOR PASSIVE MONITORING OF DIVER ASCENT RATES

(76) Inventor: Thomas Dakin, Sidney (CA)

Correspondence Address: ROBERT H. BARRIGAR;BARRIGAR INTELLECTUAL PROPERTY LAW, 1007 FORT STREET, SUITE 201, VICTORIA, BC, V8V 3K5, CA

(21) Appl. No.: 12/303,678

(22) PCT Filed: Jun. 7, 2007
(86) PCT No.: PCT/CA2007/001012

§ 371 Date: Feb. 25, 2009

Related U.S. Application Data
(60) Provisional application No. 60/804,105, filed on Jun. 7, 2006.

(51) Int. Cl. G01F 23/14

(52) U.S. Cl. 73/865.1

(57) ABSTRACT

The present invention is directed to a passive ascent rate monitor that is operable to determine a diver's rate of ascent and generate a signal indicative of the determined ascent rate. In one embodiment, the ascent rate monitor outputs graduated audible signals that correspond to a plurality of ascent rate ranges. In another embodiment, the ascent rate monitor generates private audible ascent rate signals allowing a diver to determine their own ascent rate without necessarily outputting signals that may be heard by and/or interfere with their dive partners.

### FIELD OF THE INVENTION

The present invention relates to a device for use in passively monitoring a rate of ascent in underwater applications. More particularly, the present invention is directed towards an audible ascent rate device that provides ascent rate information without active monitoring.

### BACKGROUND

The sport of SCUBA (Self-Contained Underwater Breathing Apparatus) diving is rapidly becoming one of the most popular “adventure” activities. As with any sport, there are safety issues concerned with the practice of scuba diving. However, one safety concern unique to scuba diving is the ascent from deep water and high pressures to shallow water or the surface and lower pressures (e.g., atmospheric pressure). In particular, if a diver ascends from depth too quickly, gases dissolved into the diver's tissue under pressure may expand and form bubbles within the diver's tissue. These bubbles can cause tissue damage, discomfort and in some cases death. The formation of damage-causing bubbles in the body is known variously as decompression illness and the bends.

Decompression illness is a physiological condition caused by the effect of pressure on gases. As a diver descends deeper, ambient pressure acting on the diver's body increases. In order for the diver to inflate his lungs to breath, air must be supplied to the diver at a pressure equal to the ambient pressure. The increased air pressure raises the partial pressures of each gas in the mixture being breathed (nitrogen and oxygen if air is being breathed). The increased partial pressure of each gas in the mixture forces some of the gas into the blood and tissues of the diver in order to equalize the partial pressures between the air breathed and the tissues of the diver. Thus as the diver descends, pressure increases and more nitrogen and oxygen is forced into the tissues. Conversely, as the diver ascends the partial pressure of the gases dissolved in the tissues becomes greater than the partial pressures of the air breathed, and gases are exhausted through the lungs in order to equalize the partial pressures again.

The rate of gas exchange via the lungs and circulatory system is limited. Therefore if the diver ascends too rapidly the circulatory system and lungs cannot vent the gases quickly enough. When this occurs the gases come out of solution in the tissues and blood in the form of bubbles. These bubbles can block arteries or cause trauma in tissues. The results can be both painful and deadly.

Since the metabolically inert gases such as nitrogen and helium pose the greatest threat only these gases are monitored for decompression sickness. Thus sport divers must monitor their nitrogen loading (commercial and technical divers must monitor both nitrogen and helium loading). This is done through the use of tables or diving computers. Both methods assume that the diver will ascend no faster than a specified rate. The maximum safe ascent rate has been set at 60 feet per second (18 m/s) for many years. Recent tests now indicate an ascent rate of 30 feet per second (9 m/s) reduces bubble formation in the blood stream significantly. 30 feet per second is therefore the current recommended ascent rate. Since bubble formation in the body can be so dangerous, adhering to the maximum ascent rate is crucial for all divers. Additionally, a stop at a predetermined distance beneath the surface prior to the diver surfacing is recommended.

Monitoring one's rate of ascent at the end of a dive can be difficult, as diving is an equipment intensive sport that requires concurrently performing multiple tasks to ascend safely. For example, standard instruments that must be monitored include a depth gauge to show current depth and a submersible pressure gauge to show the amount of air remaining in the air supply or tank. A diver also carries a timing device, so that they can calculate the amount of nitrogen present in their body. In recent years, these devices have sometimes been combined into a single device called a dive computer. These dive computers show depth, air pressure, nitrogen loading, dive time, temperature, and can include displays for ascent rate as well. These devices suffer from the fact that the diver must actively monitor the outputs.

In order to overcome this deficiency, some dive computers also incorporate an audible alarm that activates when a predetermined allowable ascent rate is exceeded. That is, when a diver exceeds a threshold ascent rate, the alarm sounds. This allows the diver to be informed, without having to monitor, thereby relieving the diver of unnecessary tasks. While these alarms provide a warning to a diver to slow their ascent rate, do not provide any ascent rate information other than that the current rate of ascent is beyond an acceptable value. This presupposes that there is a correct rate of ascent and that rate is input into the device prior to diving. As was described in the foregoing, there is may also be a required stop, and such a stop could not be monitored by using the alarm. Hence, even with an alarm, the diver will have to revert to actively monitoring outputs. Furthermore, in group diving situations, these audible alarms may create confusion between the various divers as to which diver is ascending too rapidly.

The utilization of dive computers represents a significant step in ensuring the safety of a diver, since older methods of equipment and ascent monitoring were difficult and unreliable. Nonetheless, the ascent portion of the dive remains one of the most difficult due to the many tasks a diver must perform in order to ascend safely. First, the diver needs to ensure that the path to the surface is clear of obstructions. Surfacing into a dock, boat, or dangerous marine organism can be startling at best, and fatal at worst. Accordingly, many training agencies recommend raising one arm while ascending in order to provide further warning/protection against accidental collision with an overhead obstacle. Second, a diver also needs to keep visual contact with their dive partners, as it is easy to become separated during an ascent, especially in low visibility conditions. Third, a heads up position should be maintained, in order to avoid disorientation in the water column.

Concurrent with the above-noted tasks, a diver must control their rate of ascent with a buoyancy compensator. Accordingly, the diver's rate of ascent must be monitored in some fashion. The current method is to monitor a visual graph on a dive computer in addition to monitoring the ascent path and dive partners and maintaining a heads up position. Furthermore, maintaining the dive computer in a position where the ascent rate can be monitored makes it difficult to control the buoyancy compensator while maintaining a raised arm. In this regard, some sort of juggling is required to view the ascent graph and control the buoyancy compensator. Furthermore, in an emergency situation, a diver may have to control another diver's buoyancy compensator, monitor breathing of an unconscious diver, and/or maintain close contact with another diver, further complicating the process.

Finally, many agencies recommend a safety decompression stop at a predetermined distance beneath the surface prior to the diver surfacing to ensure nitrogen is expelled from the tissue prior to reaching atmospheric pressure. During the recommended safety stop, the diver needs to stop their ascent at or near the recommended depth and remain there for a predetermined duration. This requires the diver to monitor their depth more or less constantly during the safety stop, time the stop, and monitor their remaining air supply.

The ascent monitors of the prior art require active monitoring in order for a diver to obtain sufficient information to safely ascend, stop and reach the surface. It is an object of the invention to overcome the deficiencies in the prior art.

### SUMMARY OF THE INVENTION

The present invention is based on the premise that a device which provides for monitoring a diver's rate of ascent in a manner that minimizes the divers need to interact with said device would simplify the ascent process. Said device can be located on the diver or their equipment such that the information delivered to the diver will not be available to other divers in the group. In this regard, the present invention provides an ascent rate monitor that determines a diver's rate of ascent and generates an output indicative of the measured ascent rate. The ascent rate information will be presented to the diver such that a diver may constantly control their buoyancy compensator while maintaining a raised arm to protect themselves from overhead obstructions. Moreover, such information can be provided privately, in accordance with the present invention, so as to avoid confusion or annoyance in group diving situations.

In one embodiment of the invention, a device, for use with a suitably selected power source, for passively monitoring ascent rate in an aqueous environment is provided. The device comprises:
an ascent rate sensor for determining a rate of ascent within an aqueous environment, the ascent rate sensor further operative to generate an output indicative of the rate of ascent;
a transducer for generating signals, the transducer selected to provide passively monitored signals; and
   a modulator for controlling the operation of the transducer, wherein the modulator is operative to receive the output and selectively control the transducer to produce one of a plurality of predefined signals corresponding to one of a plurality of predefined ascent rate ranges, such that a diver can passively monitor rate of ascent.

In one aspect of the invention, the ascent rate sensor comprises a pressure sensor operative to sense ambient pressure and provide a plurality of temporally separated outputs indicative of pressure and a controller in communication with the pressure sensor, the controller to obtain an initial output and at least one temporally separate subsequent output from the pressure sensor for use in calculating the rate of ascent.

In another aspect of the invention, the modulator is operative to control the transducer to produce a plurality of signals, each signal corresponding to a predefined approximate ascent rate.

In another aspect of the invention, at least one of the signals corresponds to an ascent rate of greater than 30 ft/second.

In another aspect of the invention, at least one of the signals corresponds to an ascent rate of greater than 60 ft/second.

In another aspect of the invention, the modulator is further operative to control the transducer to generate a stop signal indicating a start of a decompression stop and a start signal indicating an end of the decompression stop.

In another aspect of the invention, the transducer produces signals that vary in at least one of tone, colour, intensity, number and duration.

In another aspect of the invention, the pressure sensor is a strain gauge.

In another aspect of the invention, the transducer is an acoustic transducer.

In another aspect of the invention, the acoustic transducer produces a plurality of different tone frequencies, each the tone frequency corresponding to a different one of the plurality of predefined ascent rate ranges.

In another aspect of the invention, the acoustic transducer comprises a piezo-electric transducer.

In another aspect of the invention, the transducer has a maximum volume such that the signal becomes in inaudible in water at approximately 1 meter from the device.

In another aspect of the invention, the transducer further comprises a volume control.

In another aspect of the invention, the monitor is further operative to control the transducer to generate signals corresponding to the one of a plurality of predefined ascent rate ranges on a periodic basis.

In another aspect of the invention, the device further comprises a water switch operative to activate the monitor upon immersion in water.

In another aspect of the invention, at least the acoustic transducer is adapted for mounting proximate to a diver's ear.

In another aspect of the invention, at least the acoustic transducer is adapted to be mounted within approximately 5 inches of a diver's ear.

In another aspect of the invention, at least the transducer is adapted for attachment to a mask.

In another aspect of the invention, the device further comprises a housing for housing the device wherein the housing has no dimension greater than about 3 inches.

In another aspect of the invention, the device further comprises a housing for housing the device wherein the housing has no dimension greater than about 2 inches.

In another aspect of the invention, the transducer is a light emitting transducer.

In another aspect of the invention, the transducer is a pressure emitting transducer.

In another aspect of the invention, the device is adapted for integration into a dive computer.

In another aspect of the invention, the device is adapted for integration into a dive computer.

In another embodiment of the invention, a device, for use with a suitably selected power source, for passively monitoring ascent rate in an aqueous environment is provided. The device comprises:
an ascent rate sensor comprising a pressure sensor, for determining a rate of ascent within an aqueous environment, the ascent rate sensor further operative to generate an output indicative of the rate of ascent;
an acoustic transducer for generating acoustic signals;
   a modulator for controlling the operation of the transducer, wherein the modulator is operative to receive the output and selectively control the transducer to produce one of a plurality of predefined acoustic signals corresponding to one of a plurality of predefined ascent rate ranges, such that a diver can passively monitor rate of ascent; and
   a housing to house the pressure sensor, acoustic transducer and modulator, the housing adapted for attachment to a diver's mask and being at most approximately 32 cubic centimeters.

In another embodiment of the invention a method for passively monitoring a diver's ascent is provided. The method comprises employing a passive monitoring device to: determine a rate of ascent of a diver in an aqueous environment;

correlate the rate of ascent to one of a plurality of predefined ascent rate ranges; and generate one of a plurality of predefined audible signals, wherein the one output corresponds to one of the predefined ascent rate ranges, thereby providing information to a diver to permit passive monitoring of their ascent rate.

In one aspect of the invention, the step of determining further comprises:

obtaining first and second temporally distinct pressure measurements for use in calculating the rate of ascent.

In another aspect of the invention, generating each the audible signal comprises generating different series of tones each corresponding to a different ascent rate.

In another aspect of the invention, the audible signals are generated on a periodic basis.

In another aspect of the invention, no signal is generated until a predetermined ascent rate is achieved.

In another aspect of the invention, the method further comprises:

generating an audible decompression stop signal indicating the start of a decompression stop when the diver arrives at a predetermined distance from the surface during ascent.

In another aspect of the invention, the method further comprises:

generating an audible decompression start signal after a predetermined duration indicating the end of the decompression stop.

### BRIEF DESCRIPTION OF THE DRAWINGS

FIG. 1 shows a perspective view of the ascent rate monitor in accordance with an embodiment of the invention.

FIG. 2 shows a block diagram of the internal components of the device of FIG. 1.

FIG. 3 shows the device of FIG. 1 attached to a diver's mask strap.

FIG. 4 shows a second embodiment of the ascent rate monitor in accordance with the invention.

FIG. 5 shows a flow chart of a typical process utilized by the ascent rate monitor of FIG. 1.

### DETAILED DESCRIPTION

### Definitions

Signals: Signals are specific outputs that do not require the user to use cognitive perception. Signals include, but are not limited to light, colour, pressure and sound.

Active monitoring and actively monitored devices: Active monitoring uses devices that produce an output that requires the user to employ cognitive perception. For example, actively monitored devices include, but are not limited to devices that require the user to read outputs, or interpret charts or graphs.

Passive monitoring and passively monitored devices: Passive monitoring uses devices that produce a signal. They do not require the user to use cognitive perception. In other words, the device provides an output that is recognized on a physiological level. For example, passively monitored devices include, but are not limited to devices that emit signals that can be heard, seen or felt, such as beeping, flashing light, or tapping.

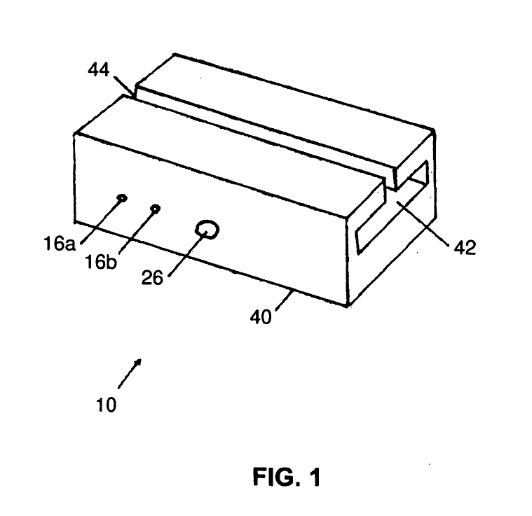

An ascent rate monitor, generally referred to as 10, is shown in FIG. 1. As shown, the monitor 10 has dimensions of approximately 2 inches in length, 1 inch in width, and ½ and inch in thickness. This allows the monitor 10 to be conveniently connected to a diver's headgear as will be discussed herein.

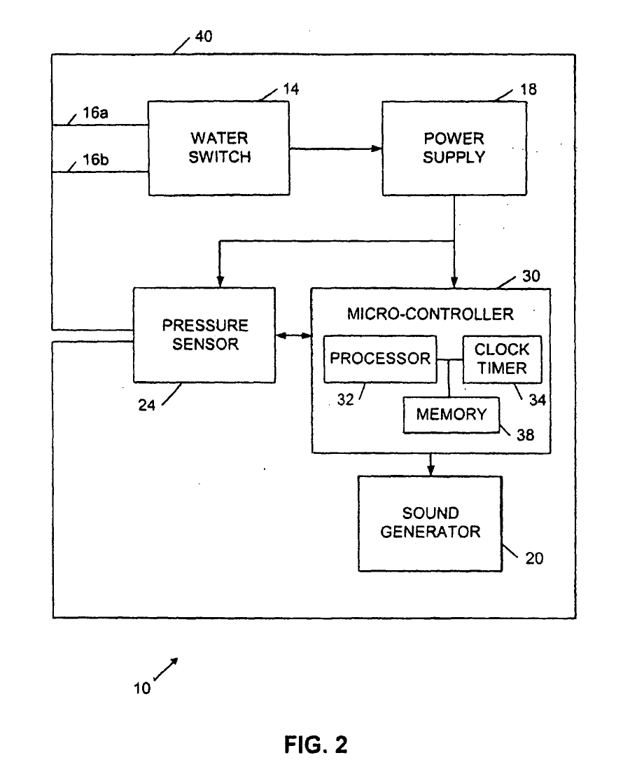

FIG. 2 shows a block diagram of the components within the monitor 10. These components include a water activated switch 14, a power supply 18, a transducer 20, a pressure sensor 24, and a micro-controller 30. Each of these components is disposed within the housing 40 of the monitor 10. In one embodiment, these components are potted within the housing 40 such that they are substantially protected from the environment. However, other means of protecting the electronic circuitry from the environment may be employed.

As shown in FIG. 2, the water activated switch 14 has first and second leads 16a-b, each of which extend to the perimeter of the housing 40. These leads 16a-b are exposed outside the housing 40 and form an open electrical circuit. Upon immersion in water, water on the outside of the housing 40 completes the electrical circuit between the leads 16a-b, activating the switch and applying power to the monitor 10. Likewise, upon removal from water, the circuit between these leads 16a-b is broken and the monitor 10 is powered off. Said switch may have an electronic control circuit that includes a time delay to prevent on-off cycling when at the surface. The water switch 14 provides a convenient mechanism for activating/deactivating the monitor 10 that tends to prolong the life of the power supply 18 as the monitor 10 automatically powers off when not in use. However, it will be appreciated that any switching mechanism may be incorporated within the monitor 10.

The power supply 18 comprises a battery encased within in the housing 40. In one embodiment, the battery is a small, long shelf life battery of 180 mAhr capacity or better, such as a CR2032 lithium coin cell. Due to the low power requirements of the monitor 10, this battery can provide several thousand hours of submerged operation and have a long shelf life. As will be appreciated, other power sources may be utilized, including rechargeable batteries.

In the embodiment shown, the pressure sensor 24 is used to measure the ambient water pressure. In this regard, while being encased within the housing 40, the pressure sensor 24 interfaces with a fluid channel 26 extending through the housing 40 that allows the sensor 24 to be in fluid contact with the surrounding water. In the present embodiment, the pressure sensor 24 is a module composed of a silicon wafer strain gauge pressure sensor 23 with a built in digital controller 25 that allows the pressure sensor 24 to communicate directly with the main microcontroller 30. The power supply 18 provides a regulated voltage to both the pressure sensor 24 and the microcontroller 30. The microcontroller 30 reads the pressure from the pressure sensor 24 in 1 second intervals. The microcontroller 30 calculates the position, time and ascent rate then generates the required drive signals for the acoustic transducer.

The digital output of the pressure sensor 24 is proportional to the potential across the strain gauge, which is proportional to the deformation of the silicon wafer, which is proportional to the pressure applied by the ambient water. Accordingly, by sampling the digital output and comparing it to stored calibration values or a calibration equation, the microcontroller 30 is operable to calculate a pressure value associated with the pressure sensor output. Since pressure in water is linearly proportional to depth, the pressure value may be utilized to determine a depth value. A built in routine to calculate atmospheric pressure on initial start up at the surface may be applied in the calibration routine. In the present embodiment, a silicon wafer-type strain gauge was selected for its diminutive size; however, other embodiments of the monitor 10 may utilize other pressure sensor devices.

As noted, the microcontroller 30 is operative to selectively sample the output from the pressure sensor 24 to calculate depths associated with the monitor 10. In this regard, the microcontroller 30 includes a processor 32, a clock/timer 34 and a memory 38. The memory 38 stores calibration information for the pressure sensor 24 as well as a plurality of control signals for controlling the transducer 20, as will be discussed herein. Furthermore, the memory 38 stores subroutines for use in providing audible ascent rate information. Finally, the memory 38 also stores a series of successively determined pressure/depth values for use in determining a rate of ascent.

In order to calculate a rate of ascent, the processor 32 compares first and second temporally distinct pressure values or depth values and divides the time between these values to determine an ascent rate. Upon determining such ascent rate, the processor 32 selects one of a plurality of predefined control signals. These control signals modulate the output of the transducer 20 to generate a signal associated with the determined rate of ascent. In this particular embodiment, the processor 32 compares the determined ascent rate to five ascent rate ranges. The first range corresponds to a rate of ascent of less than 30 ft/min, which is typically considered an optimal rate of ascent to allow for off gassing of dissolved gasses within a diver's body. A second ascent rate range corresponds with a rate of ascent between 30-40 ft/min; a third ascent rate range corresponds with a rate of ascent between 40-50 ft/min, a fourth ascent rate range corresponds with a rate of ascent between 50-60 ft/min; and a fifth ascent rate range corresponds with a rate of ascent greater than 60 ft/min, which is typically considered as exceeding the maximum safe ascent rate. Each of the five ascent rates may be indexed to stored control signals within the memory 38. Upon determining the rate of ascent, a control signal corresponding to the appropriate ascent rate range may be sent to the transducer 20. For example, rates of ascents less than 30 ft/min (i.e., the first range) may correspond to a control signal that results in no output signal being generated. That is, if ascending within this optimal range, no audible signals may be provided to the diver, who may then feel free to proceed. A rate of ascent in the 30-40 ft/min may result in the transducer 20 outputting a single signal; the 40-50 ft/min range may result in outputting a series of two signals; the 50-60 ft/min range may result in outputting a series of three signals; and an ascent rate of greater than 60 ft/min may result in outputting a series of four signals. As will be appreciated, the signal can be any signal that can be perceived by the diver, including, but not limited to sound, light, vibration, or electrical pulse. There are also numerous ways of modulating the signal, for example, but not limited to tone, duration, number, intensity, and colour. Utilization of a distinct series of beeps, for example, for each ascent rate range provides a graduated schedule that is easy for a diver to memorize. Additionally, utilization of such graduated series of beeps provides a monitor 10 with low power requirement, thus extending the monitor's useful life.

In one embodiment, the transducer 20 is an acoustic transducer 20. It may comprise any unit operable to output audible tones in response to a modulated control signal. For reliability and size purposes, a piezo-electric crystal was selected for the illustrated embodiment. In this regard, upon receiving a control signal from the controller 40, the piezo-electric acoustic transducer 20 vibrates, producing sound. Irrespective of the type of acoustic transducer 20 utilized, the acoustic transducer 20 of the present embodiment provides a private, audible signal to a diver. In this regard, a diver may be able to hear his own ascent rate monitor 10 while not being able to hear the ascent rate monitors of other divers within their party. In this regard, there is no cross talk between dive partners, reducing the chance of confusion. In order to provide private audible signal, the acoustic transducer 20 typically provides a sound output of volume only audible over an underwater distance of less than about 1 meter.

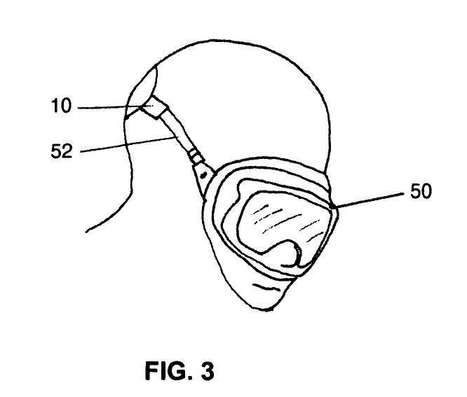

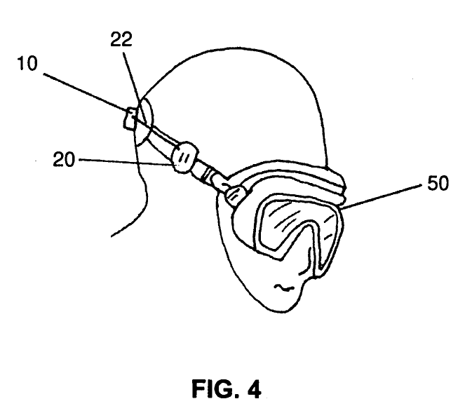

To provide such private audible signals, it is preferable to mount the acoustic transducer 20 close to a diver's ear such that they can clearly hear the low amplitude acoustic signals. FIGS. 3 and 4 show first and second embodiments of the ascent rate monitor 10 interconnected to a diver's headgear. In particular, FIG. 3 shows the monitor 10 of FIG. 1 interconnected to a strap 52 of the diver's mask 50. Referring briefly to FIG. 1, it should be noted that the housing 40 includes an integrally formed clip 42. This clip 42 extends through the housing 40 along its longitudinal axis and includes a slot 44 through which a diver may insert the strap 52 of their dive mask 50. When so inserted as shown in FIG. 3, the ascent rate monitor may be worn substantially over the diver's ear. FIG. 4 shows an alternate embodiment of the ascent rate monitor 10 wherein the acoustic transducer 20 is separate from the main housing 40 of the monitor 10. In this regard, the acoustic transducer 20 is interconnected to the microcontroller 30 via a flexible cable 22.

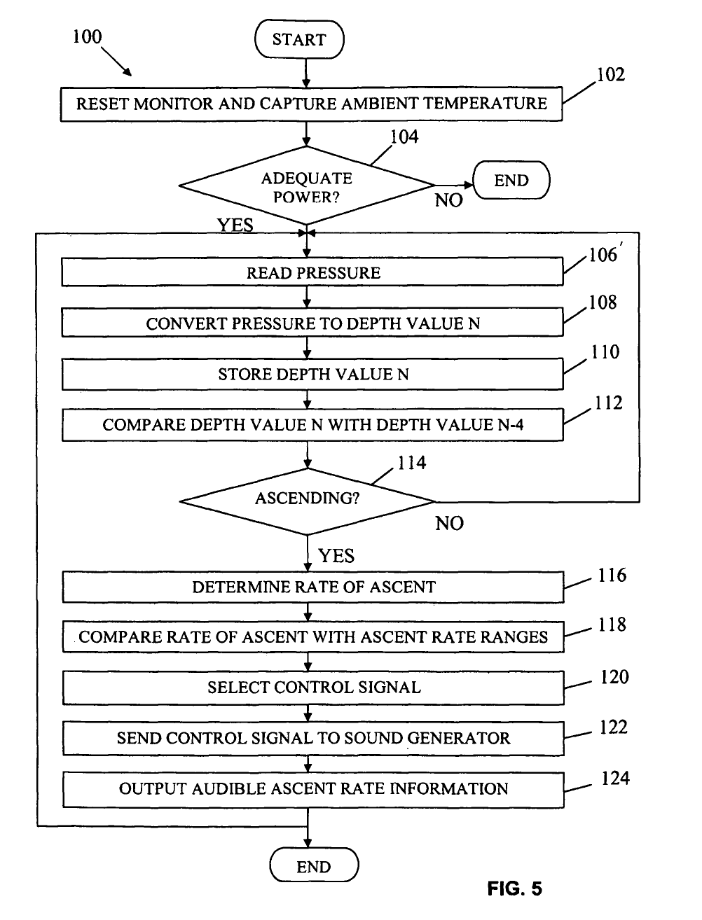

FIG. 5 shows a flow chart of a typical embodiment of a process 100 utilized by the ascent rate monitor 10 for use in providing graduated audible ascent rate information to a diver. Upon power application (e.g., immersion in water), a reset routine can be used 102 in which the monitor 10 configures its ports, timers and processor 32. Additionally, the microcontroller 30 also captures a water surface pressure reading from the pressure sensor 24 during the reset routine. This pressure reading is stored and utilized to subtract an atmospheric offset from subsequent pressure readings. A battery voltage is then obtained 104 to determine if the monitor 10 is operating within an acceptable range. If the battery voltage is below a safe level for the battery to support the proper functioning of the monitor for several more hours then the process ends. The safe level chosen for the prototype configuration was 2.5 volts. If the battery voltage is above 2.5 volts, a “good battery” tone is generated. This tone tells the diver that the unit is functioning and capable of supporting the diver for several more hours, and the process proceeds. The monitor 10 then enters a main one-second loop. In this loop, the monitor 10 reads 106 a pressure from the pressure sensor 24 and converts 108 this information to a depth value. This depth value is stored 110 within the memory 38 for future use. The monitor 10 then compares 112 the last obtained depth value with a depth value from four previous readings (e.g., four seconds previous), to calculate a rate of ascent. Initially, the monitor 10 determines 114 if the diver is ascending. If the diver is not ascending, the loop continues. If the diver is ascending, the current rate of ascent is determined 116 and compared 118 with the previously defined ascent rate ranges. An acoustic transducer control signal is selected 120 that corresponds with the ascent rate range in which the current ascent rate is included. This control signal is sent 122 to the acoustic transducer 20, which outputs a sound 124 as modulated by the control signal. The process now continues until the monitor 10 switches off. As will be appreciated, during ascent the diver is provided with an ascent rate every second.

Additionally, a safety stop subroutine is initiated upon the device descending below 25 feet of water. In this regard, upon ascending to about 15 feet from the surface, the controller 30 will provide a safety decompression control signal to the acoustic transducer 20. The corresponding stop signal notifies a diver to stop for a safety decompression stop. This safety stop allows for further off gassing thereby providing a margin of safety to the diver. The safety stop procedure at the end of every dive is recommended by numerous scuba training agencies. Accordingly, the monitor 10 may time this safety stop and at the end of a predetermined time (e.g., three minutes) provide a start signal that notifies the diver that it is safe to proceed.

The foregoing description of the present invention has been presented for purposes of illustration and description. As would be known to one skilled in the art, variations that do not alter the scope of the invention are contemplated. For example, additional features may also be incorporated into the present invention. These may exist individually or in any combination. In one embodiment the device may contain a water-activated switch that automatically turns the unit on when it is immersed in water. As will be appreciated, such an embodiment may require an electronic circuit to ensure that movement in and out of the water (for example swimming at the surface) does not turn the unit on and off with each immersion cycle. A device configured in this manner may incorporate a signal to indicate proper functioning of the device. The ascent rate sensor may comprise any unit that allows for determining a rate of ascent within an aqueous environment. As will be appreciated, numerous devices exist for determining a rate of ascent within an aqueous environment. Such devices include, but are not limited to sonar and/or pressure determining devices that determine a rate of ascent by calculating a change in depth, or pressure, over time. For example, such an ascent rate sensor may include a pressure sensor for sensing ambient water pressure and a controller to obtain first and second temporally distinct outputs from the pressure sensor for use in calculating the rate of ascent. In this regard, a first pressure may be converted into a first depth and a second pressure may be converted into a second depth. The difference between these depths over time represents the rate of ascent. Such an ascent rate sensor may utilize any number of pressure sensors including, without limitation, strain gauge elements, gas bladder sensors, resistive plunger sensors, and/or piezo-electric crystals. However, in order to make a compact unit, a strain gauge unit (e.g., silicon wafer type) may be preferable. Likewise, if the monitor is for sound production, it may utilize any of a plurality of different acoustic transducers to produce the graduated audible signals. These generators may include, for example, tone speakers, diode buzzers, and/or piezo-electric crystals. A volume control may be provided. For pressure, power and size considerations, a piezo-electric crystal may be preferable. In another embodiment the signal of the monitor could be a vibration transmitted to the body of the diver where audible alarms are not appropriate. In yet another embodiment the information may be displayed in a HUD or “heads-up-display”. All of the above embodiments do not exclude other forms of annunciation that substantively retain the requirements of minimal required interaction by the diver and restriction of said enunciation to the diver on which the device is attached.

Irrespective of the type of ascent rate sensor(s) and acoustic transducer(s) utilized, the monitor preferably includes a modulator to control the transducer such that the graduated/varied signals may be produced. The modulator may be any component that is operable to generate a plurality of different control signals for the transducer in response to an ascent rate signal received from the ascent rate sensor. For example, the modulator may comprise a processor and memory structure to store, or construct, a plurality of control signals indexed to a corresponding plurality of predefined ascent rate ranges. In this regard, upon receiving an ascent rate from the ascent rate sensor, the modulator may compare the ascent rate to the stored ranges and select an appropriate control signal. As will be appreciated, the modulator may share one or more components with the ascent rate sensor. For example, if the ascent rate sensor includes a processor and memory structure for taking and storing temporally distinct pressure readings to compute ascent rates, the same processor and/or memory structure of the ascent rate sensor may be utilized by the modulator.

The monitor may provide no outputs until a diver's ascent rate reaches a predetermined threshold value. Likewise, to prevent confusion, the number of ranges may be kept to a minimum. For example, the monitor may be operable to generate four outputs corresponding to four predetermined ascent rate ranges. For example, one audible beep for ascent rates of 30-40 ft/min; two audible beeps for ascent rates of 40-50 ft/min; three audible beeps for ascent rates of 50-60 ft/min; and four audible beeps for ascent rates greater than 60 ft/min. In any embodiment, the ascent rate range of greater than about 60 ft/min will preferably have a dedicated output since this ascent rate is generally considered the maximum safe ascent rate for a diver. Furthermore, depending on processing capabilities, power supply, and memory, the modulator may drive the transducer with synthesized verbal outputs of the current ascent rate. In this latter regard, ascent rate ranges having smaller increments (e.g., ascent rates ranges of each foot per minute) may be possible. However, it will be appreciated that numerous variations on the ascent rate ranges and audible outputs corresponding to the ascent rate ranges are possible and considered within the scope of the present invention.

In addition to generating a plurality of graduated ascent rate signals, the monitor may also generate one or more indicator alarms at predetermined positions beneath the surface of the water (e.g., depths). For example, the monitor may provide a warning signal upon reaching a predetermined maximum depth. In another embodiment, the monitor may generate an safety decompression signal upon the diver ascending to a predetermined depth. In this regard, many diving agencies recommend a decompression stop at between 15 and 20 feet beneath the surface, for around 3 minutes to allow for any compressed gasses within the diver's system to be expelled. Accordingly, at the end of such a decompression stop, a second signal (i.e., a clear to proceed signal) may be provided.

The transducer may be a separate unit from the ascent rate sensor and/or modulator that is interconnected to these components utilizing, for example, a flexible cable. Alternatively, the ascent rate sensor, enunciator, and modulator may all be formed within a substantially watertight unit that includes a mounting element for attaching the monitor to the diver's headgear.

In one embodiment, all the components of the monitor are cased within a housing and further potted to provide a robust waterproof system. However, such a potted monitor may contain one or more orifices allowing the ascent rate sensor access to ambient water in order to determine ascent rates. In an embodiment the monitor may be sealed in such a manner that batteries are not replaceable and the device therefore becomes “disposable” after a fixed number of hours of use. It will be appreciated that in this instance the period of effective use will be determined by a number of factors, the most significant being the design of the electronics and the capacity of the batteries used. In another embodiment provision for the replacement or re-charging of the batteries may be made.

It will also be appreciated that various aspects of the graduated audible ascent rate monitor need not be limited to such miniaturized components and may be integrated into existing dive computers.

1. A device, for use with a suitably selected power source, for passively monitoring ascent rate in an aqueous environment, comprising:
an ascent rate sensor for determining a rate of ascent within an aqueous environment, said ascent rate sensor further operative to generate an output indicative of said rate of ascent;
a transducer for generating signals, said transducer selected to provide passively monitored signals; and
a modulator for controlling the operation of said transducer, wherein said modulator is operative to receive said output and selectively control said transducer to produce one of a plurality of predefined signals corresponding to one of a plurality of predefined ascent rate ranges, such that a diver can passively monitor rate of ascent.

2. The device of claim 1, wherein said ascent rate sensor comprises a pressure sensor operative to sense ambient pressure and provide a plurality of temporally separated outputs indicative of pressure and a controller in communication with said pressure sensor, said controller to obtain an initial output and at least one temporally separate subsequent output from said pressure sensor for use in calculating said rate of ascent.

3. The device of claim 2, wherein said modulator is operative to control said transducer to produce a plurality of signals, each signal corresponding to a predefined approximate ascent rate.

4. The device of claim 3, wherein at least one of said signals corresponds to an ascent rate of greater than 30 ft/second.

5. The device of claim 4 wherein at least one of said signals corresponds to an ascent rate of greater than 60 ft/second.

6. The device of claim 3 wherein said modulator is further operative to control said transducer to generate a stop signal indicating a start of a decompression stop and a start signal indicating an end of said decompression stop.

7. The device of claim 3 wherein said transducer produces signals that vary in at least one of tone, colour, intensity, number and duration.

8. The device of claim 7, wherein said pressure sensor is a strain gauge.

9. The device of claim 7 wherein said transducer is an acoustic transducer.

10. The device of claim 9 wherein said acoustic transducer produces a plurality of different tone frequencies, each said tone frequency corresponding to a different one of said plurality of predefined ascent rate ranges.

11. The device of claim 10, wherein said acoustic transducer comprises a piezo-electric transducer.

12. The device of claim 9, wherein said transducer has a maximum volume such that said signal becomes in inaudible in water at approximately 1 meter from said device.

13. The device of claim 12 wherein said transducer further comprises a volume control.

14. The device of claim 7 wherein said modulator is further operative to control said transducer to generate signals corresponding to said one of a plurality of predefined ascent rate ranges on a periodic basis.

15. The device of claim 7, further comprising a water switch operative to activate said monitor upon immersion in water.

16. The device of claim 10 wherein at least said acoustic transducer is adapted for mounting proximate to a diver's ear.

17. (canceled)

18. The device of claim 17, wherein at least said transducer is adapted for attachment to a mask.

19. The device of claim 7, further comprising a housing for housing said device wherein said housing is at most approximately 32 cubic centimeters.

20. (canceled)

21. The device of claim 7, wherein said transducer is a light emitting transducer.

22. The device of claim 7, wherein said transducer is a pressure emitting transducer.

23. (canceled)

24. The device of claim 10, wherein said device is adapted for integration into a dive computer.

25. A device, for use with a suitably selected power source, for passively monitoring ascent rate in an aqueous environment, comprising:
an ascent rate sensor comprising a pressure sensor, for determining a rate of ascent within an aqueous environment, said ascent rate sensor further operative to generate an output indicative of said rate of ascent;
an acoustic transducer for generating acoustic signals, said signals having a maximum volume such that the signals become in inaudible in water at approximately 1 meter from said device and comprising a plurality of different tone frequencies, each said tone frequency corresponding to a different one of a plurality of predefined ascent rate ranges;
a modulator for controlling the operation of said transducer, wherein said modulator is operative to receive said output and selectively control said transducer to produce one of a plurality of predefined acoustic signals corresponding to one of the plurality of predefined ascent rate ranges, such that a diver can passively monitor rate of ascent and is operative to control said transducer to generate a stop signal indicating a start of a decompression stop and a start signal indicating an end of said decompression stop;
a water switch operative to activate said modulator upon immersion in water; and
a housing to house said pressure sensor, acoustic transducer and modulator, said housing adapted for attachment to a diver's mask and being at most approximately 32 cubic centimeters.

26-42. (canceled)
